(19) United States
(12) Patent Application Publication
(10) Pub. No.: US 2019/0093365 A1
(43) Pub. Date: Mar. 28, 2019

(54) Roof pipe ornament support

(71) Applicant: William Ralph Bond, Manassas, VA (US)

(72) Inventor: William Ralph Bond, Manassas, VA (US)

(21) Appl. No.: 16/350,449

(22) Filed: Nov. 19, 2018

(51) Int. Cl. E04D 13/00; F16B 2/06

(52) U.S. Cl. CPC E04D 13/00; E03F 5/08; F16B 2/065

(57) ABSTRACT

A decorative ornament is supported on the roof pipe of a house to improve the outward appearance of the house. The support for the decorative ornament is in the form of a cylindrical body the upper portion of which is in the shape of a castle turret and the bottom portion of which is cylindrical and slipped over the cylindrical roof pipe of a house.

### BACKGROUND OF THE INVENTION

### 1. Field of the Invention

The present invention relates to a support for an ornament on a roof pipe.

### 2. Description of the Related Art

There is little prior art on this field of endeavor. A Chinese patent CN201627312 discloses a precast ornament 1 in the apparent shape of a vase surrounding an exhaust roof pipe 2 which ornament is mainly supported by the roof of a building and is apparently stabilized by a member 3 between the inside of the ornament 1 and the exhaust roof pipe 2 as shown in FIGS. 1-5 of the Chinese patent.

### SUMMARY OF THE INVENTION

It is an object of this invention to improve the appearance of an exhaust roof pipe extending from the roof of a house which appearance is generally an eye sore when viewed from the ground on a side of the house by providing a decorative ornament over the top of the exhaust roof pipe.

It is another object of this invention to provide an ornamental support member which can be easily slid over the top or open end of an exhaust roof pipe and secured thereto by a set screw in the side of the support member.

It is another object of this invention to provide several variations of this support member in order to support several ornaments of varying types. Basically, the support member is in the shape of a castle turret that slides over the open end of a cylindrically shaped exhaust roof pipe.

The support member itself is cylindrically shaped and has a disc inserted therein which rests on a rim or ledge therein. The disc itself has several openings therein for house exhaust gas to pass therethrough. The cylindrical support member has several cut-outs around the upper end thereof for the house exhaust gas to pass therethrough. The cut-outs are preferably rectangularly shaped but may also have other shapes as long as the house exhaust gas can pass therethrough. The disc can be molded within the cylindrical support member during manufacture or may be temporally manually held inside the cylindrical support member during the attachment of the decorative ornament to the cylindrical support member, which assembly will be explained hereinbelow.

The theme of the decorative ornament itself is selected by the owner of the house such theme as military, nature, gospel, etc., and does not affect the function of the exhaust roof pipe.

Other objects and advantages for the use of the support member of this invention will become apparent upon reading the following description of which the attached drawings form a part.

### BRIEF DESCRIPTION OF THE DRAWINGS

FIG. 1 is a perspective view of the ornamental cylindrical support member of this invention.

FIG. 2 is top plan view of the ornamental support member shown in FIG. 1.

FIG. 3A is a bottom plan view of the ornamental support member shown in FIG. 1 without an inner disc.

FIG. 3B is a bottom plan view of the ornamental support member shown in FIG. 1 with an inner disc.

FIG. 4 is a side elevational view of the ornamental support member shown in FIG. 1.

FIG. 5 is a cross sectional view through lines 5-5 shown in FIG. 1.

FIG. 6 is a top plan view of a disc supported within the inner surface of the ornamental support member shown in FIG. 1.

FIG. 7 is a side elevational view of the disc shown in FIG. 6.

FIG. 8 is a schematic showing of the manual assembly of an ornamental eagle being attached to the ornamental cylindrical support member of this invention.

FIG. 9 is a view of the completed assembly of the parts shown in FIG. 8.

FIG. 10 is a view of a roof pipe and flashing typically found on the roof of a house.

FIG. 11 is a showing of the ornamental support member slid over and fixed to the cylindrical exhaust gas pipe on the roof of a house.

FIG. 12 is a view of an alternative modification of the cylindrical support member shown in FIG. 1 with a crossing bar affixed thereto.

FIG. 13 is a showing of the assembly of FIG. 12 with a pair of decorative ornaments affixed to opposite ends of the crossing bar.

FIG. 14 is a showing using an assembly similar to FIG. 13 supporting an eagle ornament.

FIG. 15 is a showing of a different ornament, i.e., a cross, supported by the ornamental support member of this invention which, in turn, is supported on the cylindrical exhaust gas roof pipe of a house.

### DESCRIPTION OF THE PREFERRED EMBODIMENTS

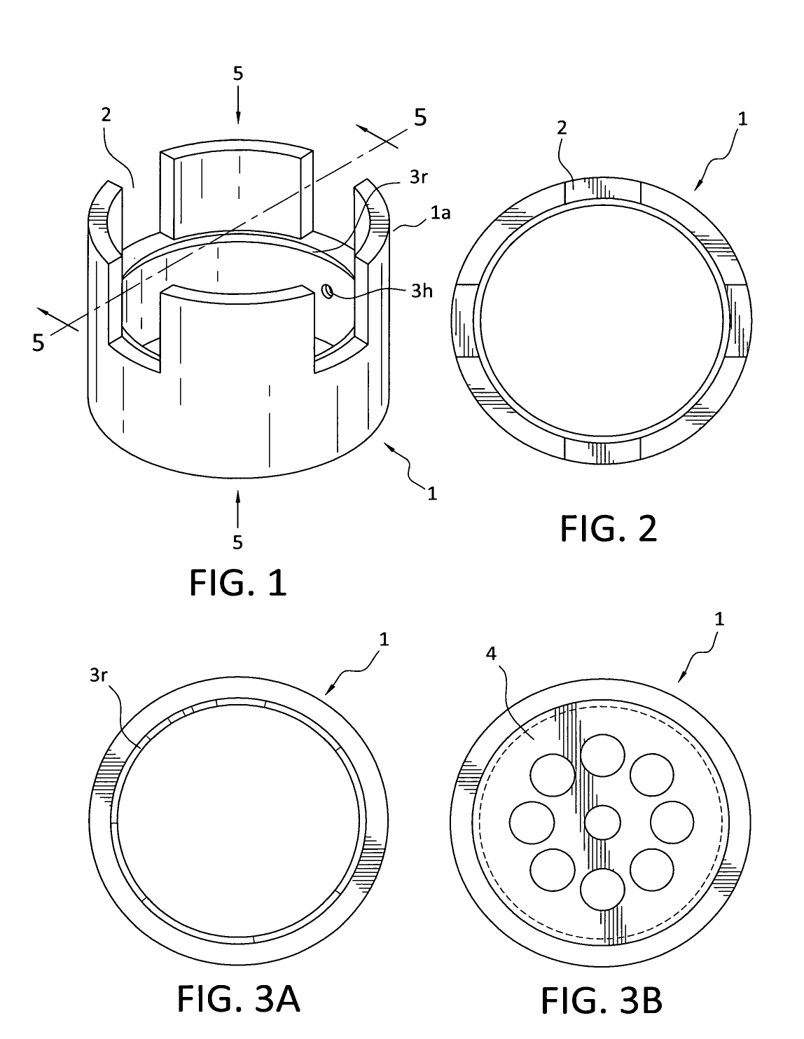

As shown in FIG. 1 the ornamental support member 1 of this invention has the general shape of a castle turret 1a with several cut-outs 2 around its periphery. To simplify the description of the ornamental support member 1 of this invention specific dimensions are given herein to fit over a roof gas exhaust pipe with a diameter of 3.5 inches although it would be obvious to one skilled in the art to readily determine the dimensions for an ornamental support member to fit over one of the other three standard size roof pipes. The shape of the cut-outs 2 in the castle turret 1a are preferably rectangular but may take other shapes as long as they allow house sewer gasses to escape to the outer atmosphere. The number of cut-outs 2 are preferably four but may be another number depending on the necessity. The radial length of each cut-out 2 is approximately 1.75 inches with a height of approximately 1 and ⅜ inches. The spacing between adjacent cut-outs 2 is approximately 1.00 inch. There is a threaded hole 3h in the wall of the ornamental support member 1 to accommodate a set screw 3s to secure the ornamental support 1 to an exhaust roof pipe RP which procedure will be explained later herein. The ornamental support member 1 of this invention may be dimensioned to accommodate different standard size roof pipes such as 1.5 inch, 2 inches, 3.5 inches and 4 inches. The outer diameter of the circumferential ornamental support member 1 of this invention is approximately 4 inches and its inner diameter is approximately 3.5 inches. The height of the ornamental support member 1 is approximately 3 inches. There is a circumferential ridge or ledge 3r on the inner surface of the ornamental support member 1 just below the four cut-outs 2 with a depth of approximately 0.20 inch and is located approximately 1 and ½ inches from the bottom end of ornamental support member 1.

In FIG. 3A, there is shown a top plan view of the ornamental support member 1 and the location of a ridge 3r on an inner wall of the ornamental support member 1.

In FIG. 3B, there is shown a bottom plan view of the ornamental support member 1 with an inner disc 4 positioned within the ornamental support member 1.

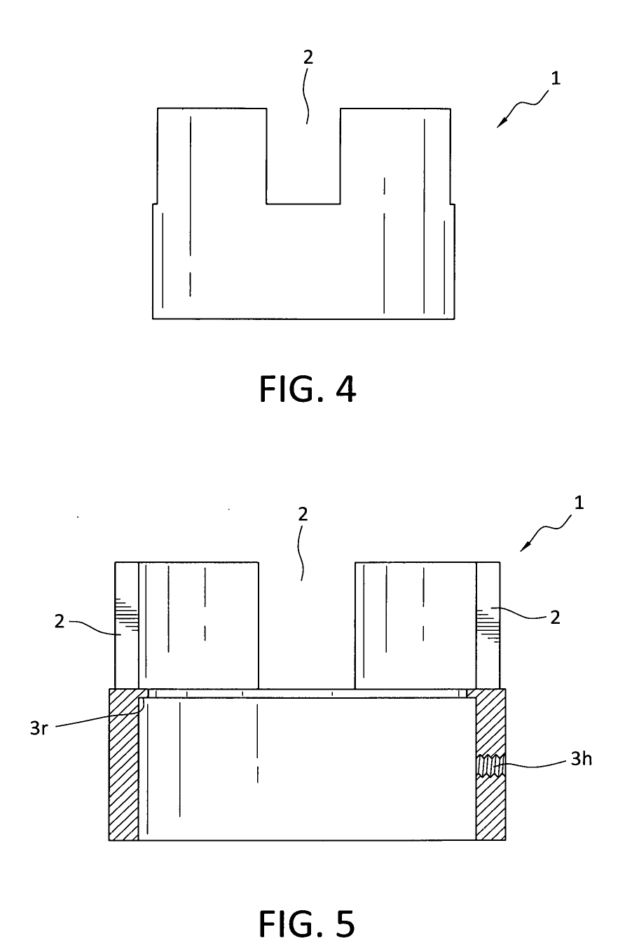

FIG. 4 is a side elevational view of the ornamental support member 1 having an approximate height of approximately 3 inches as previously explained.

FIG. 5 is a cross sectional view through lines 5-5 of the ornamental support member 1 shown in FIG. 1.

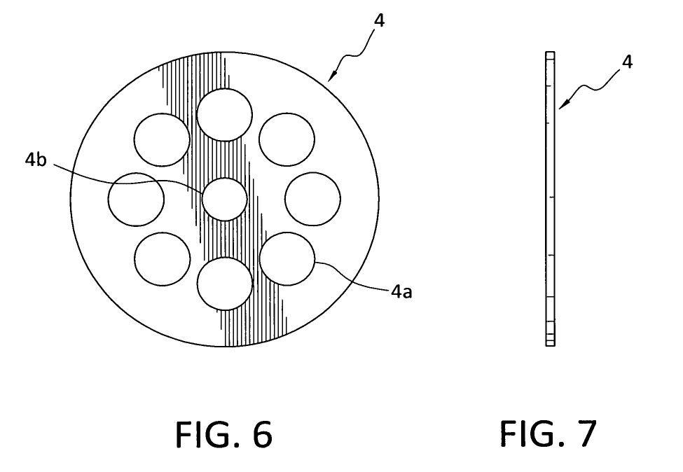

As shown in FIG. 6 the inner disc 4 has several openings 4a therein surrounding a central opening 4b. The inner disc 4 is approximately 3.50 inches in diameter. Each of the several openings 4a is approximately 0.625 inch in diameter and the central opening 4b is approximately 0.50 inch in diameter to accommodate the passage of an elongated threaded bolt TB therethrough, which will be explained later herein. The thickness of the inner disc 4 as shown in FIG. 7 is approximately 0.09 to 0.10 inch. The inner disc 4 may be manually positioned within the ornamental support member 1 to rest on the free surface of a ridge or ledge 3r (which will be explained later herein during an assembly process) or it may be molded within the ornamental support member 1 itself during a manufacturing process. The ornamental support member 1 (including its inner disc 4) of this invention is preferably made from aluminum but other suitable materials such as PVC and ABS plastics, or other suitable, durable and sturdy material may also be used.

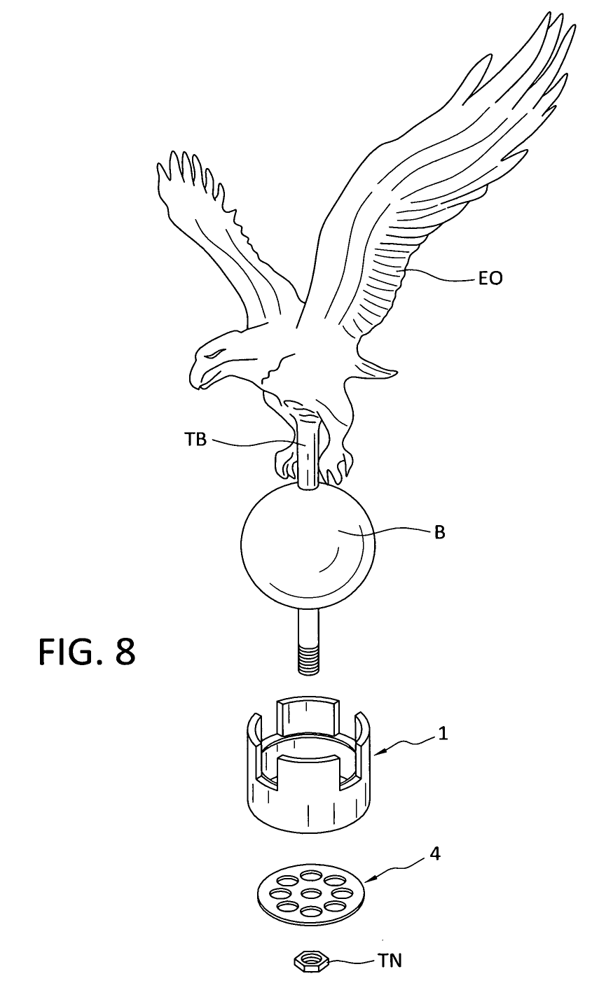

FIG. 8 shows the manual assembly of a decorative ornament EO, i.e., an eagle, being assembled to the ornamental support member 1 of this invention. In the case where the inner disc 4 is a free element: the inner disc 4 is manually inserted into the open bottom end of the ornamental support member 1 up to the inner ridge 3r while inserting an elongated threaded bolt TB (attached to the ornament EO, e.g., an eagle) through a through-hole in a ball shaped member B, and thence through the central opening 4b in the inner disc 4. Finally, a threaded nut TN is screwed onto the free end of the threaded bolt TB of the ornament EO and tightened up to the bottom free end of the inner disc 4 until all components of the assembly are securely fixed together. In the case where the inner disc 4 is molded within the ornamental support member 1 during the manufacturing process the manual step of inserting the free inner disc 4 into the ornamental support member is unnecessary. The ball shaped member B can be a solid body with a center through hole or a hollow body with opposing openings therein. The ball shaped body is preferably made from metal, e.g., aluminum, but other suitable metals or sturdy plastic materials may also be used for the ball B.

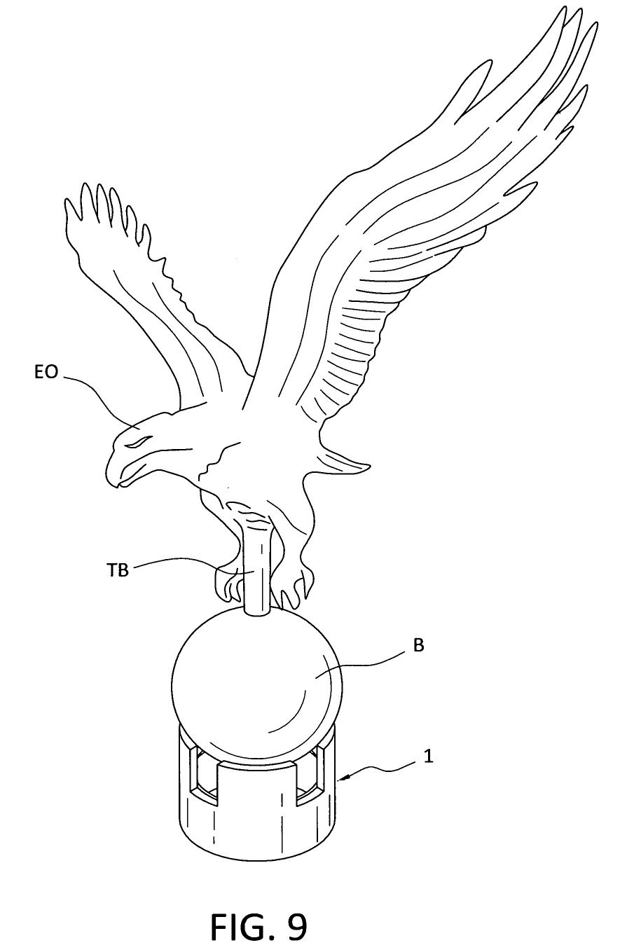

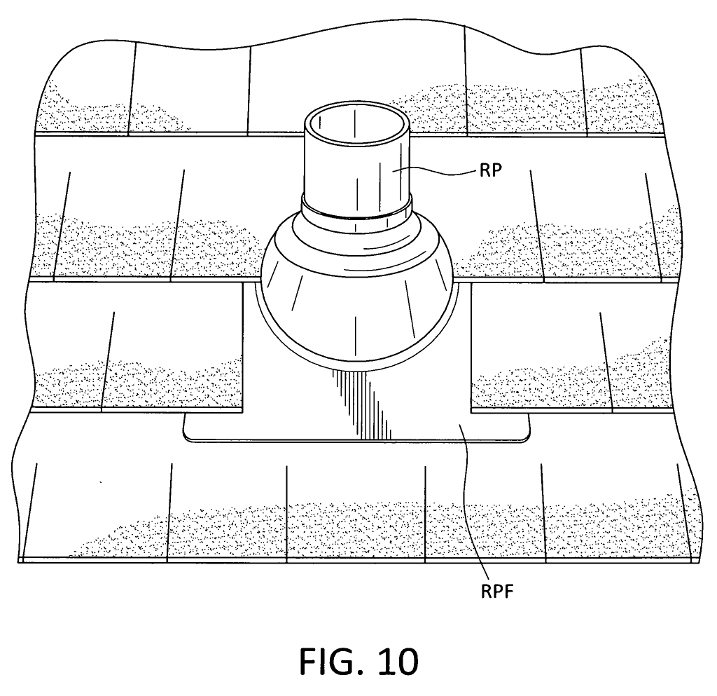

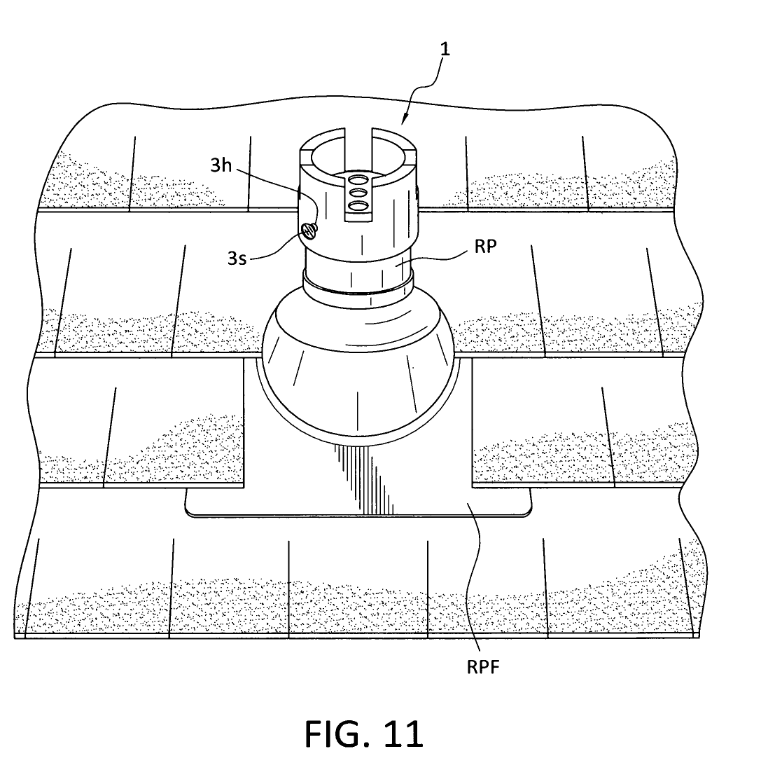

FIG. 9, as previously indicated, shows the resulting completed assembly of the components of the ornamental support member 1 with an eagle ornament EO supported thereon.

FIG. 10 shows a typical roof pipe flashing RPF with an exhaust roof pipe RP protruding therethrough which roof pipe flashing RFP is secured to the shingled roof of a house.

FIG. 11 shows the ornamental support member 1 slid over the cylindrical exhaust roof pipe RP and secured thereto by means of a threaded screw 3s which is screwed into a threaded hole 3h in the sidewall of the ornamental support member 1 and tightened making contact with the exhaust roof pipe RP.

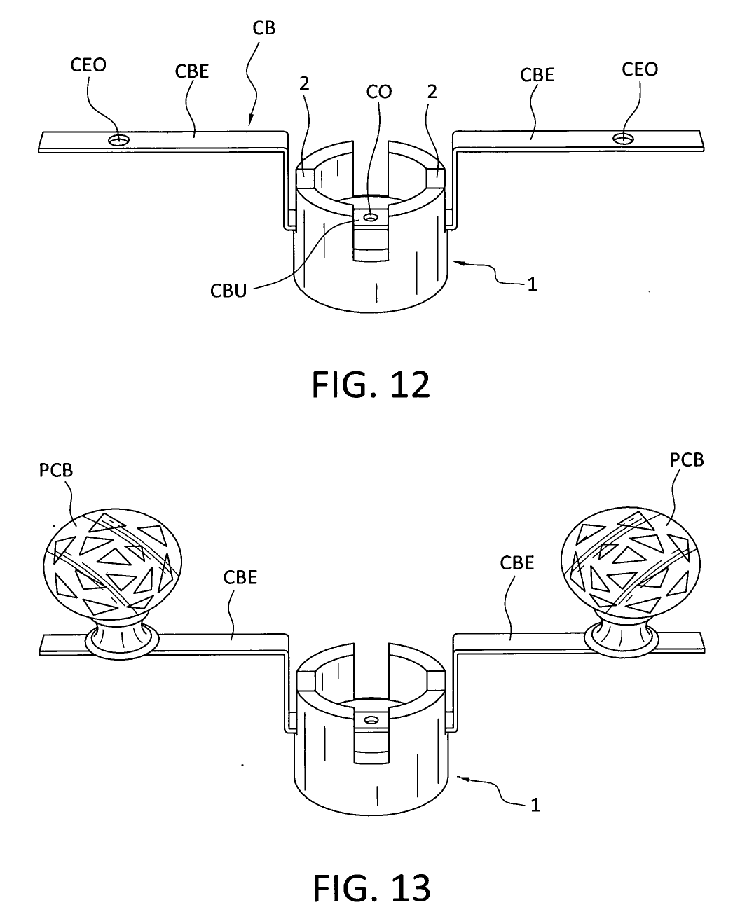

In FIG. 12 there is shown a modification of the ornamental support member 1 of this invention with a crossing bar CB positioned within a pair of opposite cut-outs 2, 2 in the ornamental support member 1. The crossing bar CB has a central U-shaped section CBU with an extension CBE from each side thereof. The bottom of the U-shaped section CBU has a length of approximately 4 and ½ inches with each upright leg of the U-shaped section having a length of approximately 2 and ½ inches. Each of the extensions CBE has a length of approximately 5 and ½ inches. The bottom of the U-shaped section CBU has a central opening CO of approximately ½ inch and each of the extensions CBE has a circular extension opening CEO of approximately ½ inch about 2 inches from its free end.

In FIG. 13, there is shown the modification in FIG. 12 of an ornamental support member 1 with a plastic crystal ball PCB supported from and near each end of the crossing bar extension CBE with a threaded bolt (not shown in FIG. 13) extending from the plastic crystal ball PCB through a circular extension opening CEO (not shown in FIG. 13). Each plastic crystal ball PCB is secured to a respective crossing bar extension CBE by means of a nut (not shown in FIG. 13).

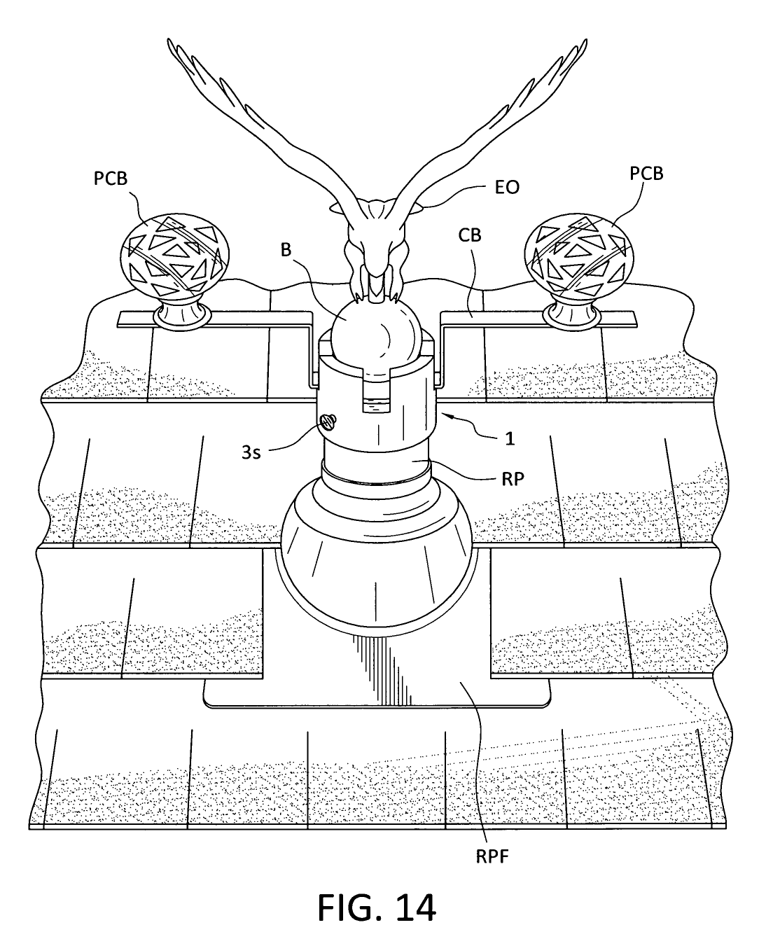

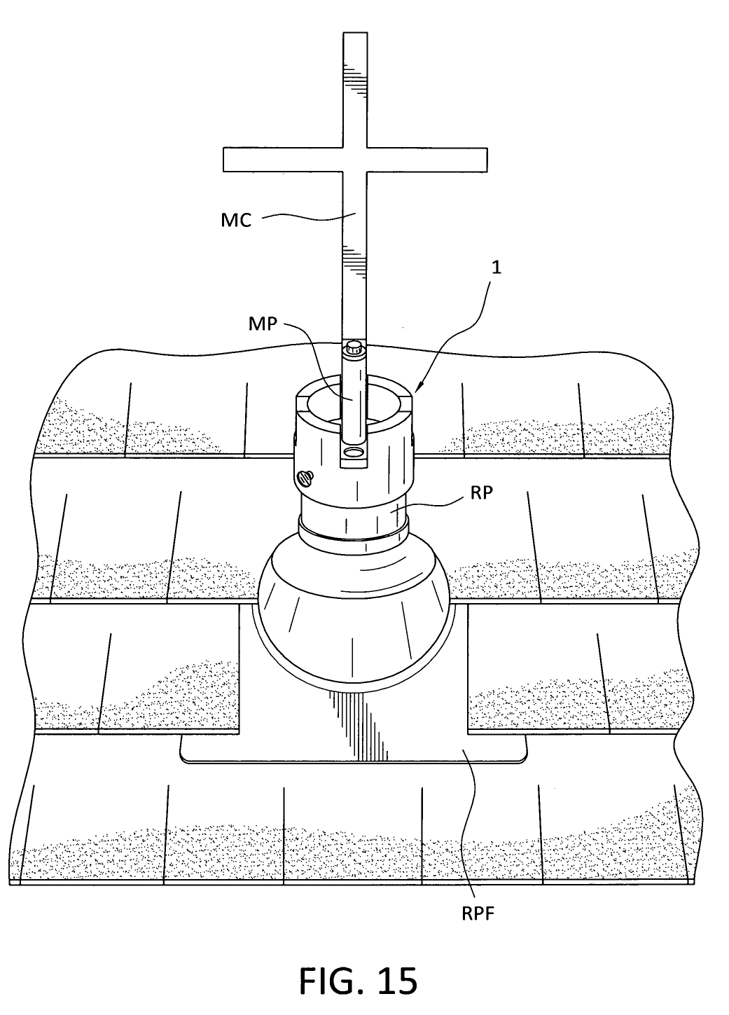

In FIG. 14 there is shown an embodiment utilizing the modification of the ornamental support member 1 shown in FIG. 13. In this embodiment an eagle ornament EO is supported from the ornamental support member 1 with a crossing bar CB inserted therein and a plastic crystal ball PCB attached to opposite ends of the crossbar CB. As would be understood by one having ordinary skill in the art ornaments other than plastic crystal balls may also be used in place thereof in this modified embodiment of the ornamental support member 1 of this invention. The ornamental support member 1, supporting the eagle ornament EO, is shown slid over the exhaust roof pipe RP surrounded by an exhaust roof pipe flashing RFP.

In another embodiment shown in FIG. 15 for the support of a decorative metal cross MC, there is a metallic pipe MP attached to the bottom end of the decorative metal cross MC which metallic pipe MP has a diameter larger than the diameter of the central opening in the metallic inner disc 4 (not identified in FIG. 15) for additional support of the metal cross MC on the ornamental support member 1. The usual elongated threaded bolt (not seen in FIG. 15) is attached to the metal cross MC and passes through the metallic pipe MP to the opposite side of the disc 4 and a threaded nut (TN not seen in FIG. 15) is screwed onto the threaded bolt (not seen in FIG. 15) up to the bottom side of the metal disc 4 and tightened to secure the decorative metal cross MC to the ornamental support member 1. Of course, one having ordinary skill in the art would readily realize that sturdy materials other than metal could also be used for the cross and pipe supporting the cross.

Modifications of this invention will be readily apparent to those skilled in the art and it is intended that the invention be not limited by the embodiments disclosed herein but that the scope of the invention be defined by the appended claims.

What is claimed is:

1. An ornamental support member for an exhaust roof pipe of a building comprising a cylindrical body having a cylindrical through hole providing a cylindrical wall in said body, said body having an upper end and a bottom end, said upper end of said body having several peripheral cut outs, said body having an inner disc positioned just below said peripheral cut outs and said inner disc having a central opening and several openings spaced around said central opening.

2. The ornamental support member of claim 1 wherein said peripheral cut outs are rectangularly shaped.

3. The ornamental support member of claim 1 wherein said cylindrical wall has an inner peripheral ledge just below said several peripheral cut outs, said inner disc being in abutment with said inner peripheral ledge.

4. The ornamental support member of claim 1 wherein said inner disc is integral with said inner wall.

5. The ornamental support member of claim 1 wherein said cylindrical wall has a through-hole to accommodate a set screw to affix said cylindrical body with said roof pipe.

6. The ornamental support member of claim 1 wherein said support member further includes an elongated bar having a U-shaped center section and opposite extensions at the upper free ends of said U-shaped center section, said elongated bar being supported within an opposite pair of said peripheral cutouts in said cylindrical body, said U-shaped center section being inserted within said opposite pair of said peripheral cutouts and said opposite extensions extending beyond said cylindrical body.

7. The ornamental support member of claim 6 wherein each of said opposite extensions has a through-hole near the end thereof.

8. The ornamental support member of claim 7 wherein there is an ornament supported at each of said extensions through said through-hole.

9. The ornamental support member of claim 1 wherein said building is a house.

10. In combination, an ornamental support member for an exhaust roof pipe of a building and a decorative ornament affixed to said ornamental support member, comprising an ornamental support member having a cylindrical body with a cylindrical through hole providing a cylindrical wall in said cylindrical body, said cylindrical body having an upper end and a bottom end, said upper end of said body having several peripheral cut outs, said body having an inner disc positioned just below said peripheral cut outs, said inner disc having a central opening and several openings around said central opening and a decorative ornament affixed to said upper end of said cylindrical body.

11. The combination of claim 10 wherein said decorative ornament is selected from the group consisting of an eagle, a cross and a weather vane.

12. The combination of claim 10 wherein said peripheral cut outs are rectangularly shaped.

13. The combination of claim 10 wherein said cylindrical wall has an inner peripheral ledge just below said several peripheral cut outs, said inner disc being in abutment with said inner peripheral ledge.

14. The combination of claim 10 wherein said inner disc is integral with said inner wall.

15. The combination of claim 10 wherein said cylindrical wall has a through-hole to accommodate a set screw to affix said cylindrical body to said roof pipe.

16. The combination of claim 10 wherein said building is a house.

17. The combination of claim 10 wherein said ornamental support member and said decorative ornament are attached together by means of an elongated bolt attached to a lower end of said decorative ornament and wherein said threaded bolt extends through said cylindrical body and through said central opening of said inner disc and wherein a threaded nut is screwed onto a bottom end of said threaded bolt up to a bottom side of said inner disc and tightened to secure said decorative ornament and said ornamental support member together.

18. The combination of claim 17 wherein there is a spherical element between said decorative ornament and said ornamental support member, said spherical element having a pair of opposite openings through which said elongated threaded bolt passes and supports said spherical element.

19. The combination of claim 17 wherein there is a threaded hole near said upper end of said cylindrical body and wherein there is a set screw screwed into said threaded hole to contact said exhaust roof pipe in order to secure said combination to said exhaust roof pipe.
